(19) United States
(12) Patent Application Publication
(10) Pub. No.: US 2020/0264736 A1
(43) Pub. Date: Aug. 20, 2020

(54) NETWORK-BASED SOCIAL PLATFORM FOR DELIVERING COMBINED DRAWING-PHOTO-TEXT-VIDEO MODULAR MULTIMEDIA STORIES

(71) Applicants: Swati Ranjan Tomar, West Lafayet, IN (US); Vikas Tomar, West Lafayet, IN (US)

(72) Inventors: Swati Ranjan Tomar, West Lafayet, IN (US); Vikas Tomar, West Lafayet, IN (US)

(21) Appl. No.: 16/868,442

(22) Filed: May 6, 2020

Related U.S. Application Data
(60) Provisional application No. 62/992,744, filed on Mar. 20, 2020.

(51) Int. Cl. G06F 3/0481; G06Q 50/00; G06F 3/0488; H04L 12/58

(52) U.S. Cl. CPC G06F 3/0481; H04L 51/32; G06F 3/04883; G06Q 50/01

(57) ABSTRACT

The present invention is directed to a system and method for providing a network-based social platform for creating and sharing stories in the form of combined drawing-photo-text-video multimedia. The social platform allows its member to post new stories and share on the social platform. The members can be presented with a template for easily creating new stories. The published stories can be arranged through an interface of the present invention, wherein such an arrangement comprises carousels with frames for representing the stories.

### CROSS-REFERENCE TO RELATED APPLICATIONS

This application claims priority to the U.S. provisional patent application Ser. No. 62/779,784, entitled “iinfer platform for combined audio-video-text modular information delivery.” filed on Mar. 20, 2020 which is incorporated herein by reference in its entirety.

### FIELD OF INVENTION

The present invention relates to a network-based social platform, and particularly relates to a social platform for authoring and sharing multimedia stories, the multimedia stories a combination of drawing, photo, text, and video.

### BACKGROUND

Network-based social platforms, such as Facebook, Twitter, and LinkedIn have increasingly become popular. Such social platforms allow their members to keep in touch with each other, share multimedia content, and discover like-minded people. The multimedia contents include pictures, blogs, news updates, recipes and many more. These social platform have become a hub for people to share their thoughts, creativity, and to keep themselves updated about events in their communities. Such social platforms present a chance to the public, in general, to showcase their thoughts.

However, the known network-based social platform suffers from one or more shortcomings. One such shortcoming is a failure to target a diverse audience. For example, some members of a platform will be interested in computer technology, Movies, News, and some in stories. Thus, the members of a known platform may be bombarded with irrelevant content, as a result, may lose interest in such platforms. Another shortcoming is the large volume of feed being posted to such platforms, the average lifetime of the feeds in popular platforms can be low and ultimately gets lost within a few minutes of posting.

Thus, a need is appreciated for an improved social platform that is devoid of the shortcoming of the known network-based social platforms. A need is appreciated for a system that allows sharing and organizing the multimedia stories. The platform should allow users to create and share stories on varied topics that combine hand-based drawing skills with popular media such as pictures, text scripting, and motion pictures at the same place, therefore, allowing deeper user engagement and interaction.

The term story hereinafter refers to a written narrative with/without images, hand drawing, audio, video, and a text script. The term story hereafter also connotes multimedia content including videos.

### SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The principal objective of the present invention is therefore directed to a novel social platform for authoring and sharing stories.

It is another objective of the present invention that the social platform permits organizing the stories into categories.

It is still another objective of the present invention that the social platform keeps its members updated about new stories.

It is yet another objective of the present invention that the social platform provides an easy way for its members to showcase their thoughts and creativity.

It is a further objective of the present invention that the social platform keeps its members updated about the news and events in their community.

It is still further objective of the present invention is that the social platform allows like-minded members to form a group.

It is yet a further objective of the present invention that social platform is easy to use.

In one aspect, certain embodiments of the present invention are directed to a novel network-based social platform that allows authoring and sharing stories. The social network according to an embodiment of the present invention allows its members to share stories. The social platform can provide an interface for interacting with the social platform. The interface can be provided through a user device, such as a desktop computer, a smartphone, and alike. The interface allows a user to sign up with the social platform of the current invention to become a member. Furthermore, the members can create a member profile through the interface.

In one aspect, the social platform through the interface allows its members to publish a story, wherein the social platform provides a template for creating a new story. In one case, the template can be based on a category of the story. In another case, the template can be a common template. The template comprises a text frame, an image container, and a video container. To create a new story, first, the member can choose the number of pages for the story. The member can be provided with options to upload multiple images, edit the uploaded images, provide a background texture, create an art, add a written narrative, and upload a video. In a preferred embodiment, the member can draw an artistic image through the interface, wherein the member can be provided with a digital canvas. The canvas comprises a pen, color templates, eraser, and like which allows the member to create an artistic image from scratch.

In one aspect, to create a new story, a member can click a node provided by the interface. In response to clicking the node, the member can be provided with a template for creating a new story. The member can upload one or more images, draw an image, or both upload the images and draw an image, provide a written narrative, and optionally upload a video. In one case, the member can choose a predetermined theme for the story. The theme comprising a background style, a foreground style, font, text size, color scheme, and other styles for the new story. In another case, the member can create a personalized theme. Still, in another case, the members can edit a predetermined theme. The member can further provide a thumbnail of the new story.

In one aspect, the social platform can attach metadata to the new-story, the metadata comprises category, date and time stamp, author information, and search keywords for the new-story. In one case the social platform can receive the images, text frame and video, through the interface, from a member. Thereafter the social platform can render the received images, text frame and video according to a theme and associate the metadata to the story. The story along with its linked metadata can be stored in a database and published to its members. Moreover, the social platform can attach a thumbnail to the new-story, wherein the thumbnail can be provided by the member or automatically generated by the platform based on a predetermined rule.

In one aspect, the social platform can present content to its members using multiple carousels arranged in the interface. The interface can be provided in a landscape configuration, wherein the carousels can be arranged horizontally and parallel to each other. A carousel comprises a plurality of frames arranged side by side in the carousel. Each of the frames can be linked to a story, wherein the frame comprises a thumbnail, a title, and a label of the story. In one case, the label can include the category of the story or author of the story. A limited number of frames in a carousel may be visible at a time, wherein a slider can be provided to each of the carousels for sliding through the frames.

In one aspect, a carousel is a collection of similar objects, for example, a carousel may represent a collection of stories belonging to a specific category. A carousel can include a collection of group members. Wherein different objects of the carousel can be represented as a thumbnail arranged side by side in the horizontal carousel. In one case, each carousel can be linked to a specific page, wherein the page list all the objects represented by the carousel.

In one case, the interface further comprises a node to create a new story. The node can be presented as a button, wherein the button can be position near the bottom of the interface. This button might have a “+” marking, wherein clicking the button opens a template for creating the story. The node can also be provided within a page, maybe along with different groups of the stories. The difference between two nodes, one at a bottom and other alongside category label of the stories, can be that the bottom node can provide a common template, while the category linked node can provide a template associated with that category.

In one aspect, the interface can provide a home page, browsing page, notification page, workgroup page, my group, group members, user profile, setting, and terms and conditions page. While the bottom of the interface can be provided with a menu to switch between different pages. The home page comprises carousels related to My group, Group members, Trending, Topics, and New. Each carousel on the home page can be linked to an associated page, for example, the trending carousel can be linked to a trending page, wherein the trending page is a collection of stories which are grouped based on predetermined criteria, for example, based on date and views of the stories. The carousel labeled browsing can be linked to a browsing page, wherein the browsing page list all the stories grouped by category. The grouped stores based on category can be represented on the browsing page using the carousels. The notification page comprises a list of notifications to the member. The list of notifications can comprise newly published stories. The workgroup page comprises a list of members of the group and the stories published by the members of the group. My group page comprises a collection of stories authored by the group members.

In one aspect, the present invention allows members to rate a story. For example, members can like or dislike a story. A widget can be provided by the interface and linked to the story being displayed. The widget can include a symbol representing a hand with thumbs up, wherein clicking a symbol adds a favorable rating to the story. Furthermore, the widget can be provided with a comment symbol which can be linked to a comments form. This may allow other members to provide comments for the story. The ratings and comments can be stored and linked to the metadata associated with the story. Furthermore, the widget can include a code for sharing and reporting the story. The share option allows a member to share the story in another group of which the person is a member. The report option can allow reporting the story to administrators or a moderator for review.

In one aspect, the members can interact with each other to offer mentoring on writing and/or on subject matter of the multimedia stories.

In one aspect, the platform can provide a different kinds of membership, for example free membership and paid member ship. Moreover, the platform can provide a way for charging a fee for creating and hosting stories, a separate fee member-based mentoring, and a separate fee for professional mentoring.

In one aspect, the social media platform can allow for commercial advertisements directed to its members. Such commercial advertisements can be placed along the hosted stories and the social platform can be further configured to charge a fee for interfacing of the hosted stories with various commercial merchandise based on member's discretion. Moreover, the members can avail one or more commercial merchandise.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the system, according to an embodiment of the present invention.

FIG. 2 is a block diagram showing the server, according to an embodiment of the present invention.

FIG. 3 is a flow chart showing the registration module, according to an embodiment of the present invention.

FIG. 4 is a flow chart showing the new story module, according to an embodiment of the present invention.

FIG. 5 is a front view of the interface in portrait mode presenting the story, according to an embodiment of the present invention.

FIG. 6 is a front view of the interface in landscape mode presenting the story, according to an embodiment of the present invention.

FIG. 7 is a flow chart showing a method of creating a new story, according to an embodiment of the present invention.

FIG. 8 is a plain view of the interface displaying the home page, according to an embodiment of the present invention.

FIG. 9 is a plain view of the interface displaying the browsing page, according to an embodiment of the present invention.

FIG. 10 is a plain view of the interface displaying the trending page, according to an embodiment of the present invention.

FIG. 11 is a plain view of the interface displaying the new stories page, according to an embodiment of the present invention.

FIG. 12 is a plain view of the interface displaying the member homepage, according to an embodiment of the present invention.

FIG. 13 is a plain view of the interface displaying the member stories page, according to an embodiment of the present invention.

Although the specific features of the present invention are shown in some drawings and not in others. This is done for convenience only, as each feature may be combined with any or all the other features in accordance with the embodiments herein.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

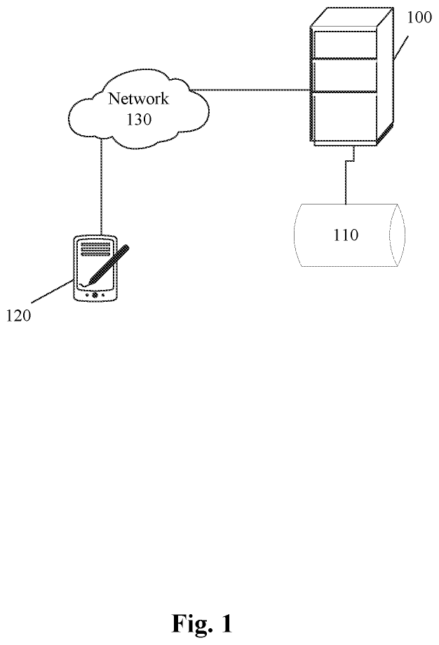

The present invention is directed to a system and methods for providing a network-based social platform that can be used for authoring and sharing stories. Now referring to FIG. 1, which is a block diagram showing the system 100 connected to a database 110. The system 100 can further be connected to at least one user device 120 through the network 130. The system 100 according to the present invention provides a social platform for authoring and sharing stories by its members. The database 110 can store the member details and stories. A skilled person will understand that in FIG. 1, the system 100 and the database 110 are shown as separate, it is possible that the database 110 can be configured into the system 100. According to certain embodiments, the user device 120 can be a computing device having a display. Examples of the computing device include a smartphone, laptop, desktop, tablet computer, personal digital assistant (“PDA”), or the like. The computing device can include an operating system, such as Android and iOS.

The system 100 can be connected to the user device 120 through the network 130. The network 130 can be wired or wireless network. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel or satellite band. The wireless network may also include any cellular network standards used to communicate among mobile devices, including standards that qualify as 3G, 4G, or 5G. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. The geographical scope of the network 130 may vary widely and the network 130 can be a body area network (BAN), a personal area network (PAN), a local-area network (LAN), e.g. Intranet, a metropolitan area network (MAN), a wide area network (WAN), or the Internet. The network 130 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include the application layer, transport layer, internet layer (including, e.g., IPv6), or the link layer. The network 130 may be a type of a broadcast network, a telecommunications network, a data communication network, or a computer network.

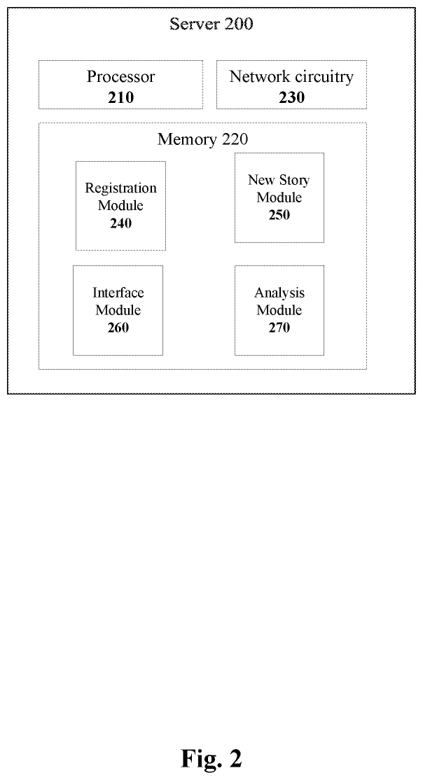

According to an embodiment of the present invention, system 100 may include a single or multiple, logically grouped servers. According to an exemplary embodiment, the servers may be geographically dispersed. One or more of the servers can include an operating system platform, for example, Windows, Unix, Linux, or Mac. An embodiment of the server 200 is shown in FIG. 2 having a processor 210, a memory 220, and a network circuitry 230, wherein the memory 220 and the network circuitry 230 are in electronic communication with the processor 210.

The processor 210 can be any logic circuitry that responds to and processes instructions fetched from the memory 220. In certain embodiments, the processor can be a microprocessor unit, e.g. Intel processors including the Intel range of processors i3, i5, and i7; Xeon processors; and AMD processor. The server 200 may be based on any of these processors, or any other processor capable of operating as described herein.

The memory 220 may include one or more memory chips capable of storing data and allowing any storage location to be directly accessed by the processor 210. The memory 220 may be a volatile memory, including Dynamic random access memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the memory 220 may be non-volatile; e.g., Non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The memory 220 may be based on any of the above-described memory chips, or any other available memory chips capable of operating as described herein.

As shown in FIG. 2, the memory includes one or modules according to the present invention which when executed by the processor 210 causes the processor 210 to perform one or more functions of the present invention. The memory 220 includes a registration module 240, a new story module 250, an interface module 260, and analysis module 270.

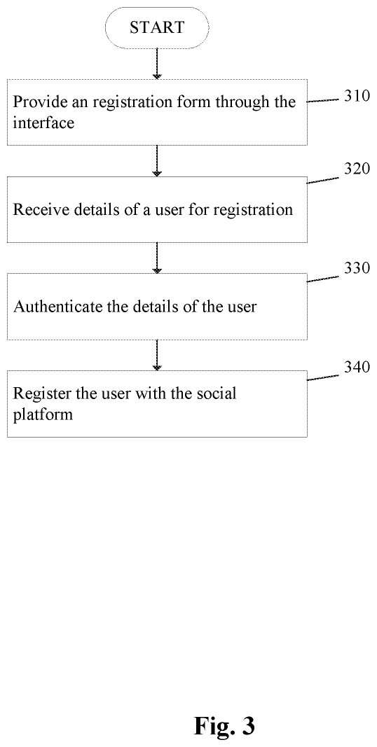

FIG. 3 shows an embodiment of the registration module 240. A user desirous to register with the social platform of the present invention can download an interface from the server 200. The interface can be provided as application software that can be installed in a user device 120. The application software can be developed for Android, iOS, and any other known operating platform for mobile devices. The application software can be made available through a distribution service provider, for example, Google Play operated and developed by Google and the app store by Apple. In addition to the application software, a website-based interface can also be provided through the world-wide-web. At step 310, the user can be presented with a registration form, wherein the user can enter details, such as name, gender, age, log-in details and like, at step 320. On receiving personal details of the user, the registration module 240 can provide for authentication of the details provided by the user. Upon successful authentication of the user, the registration module 240 can register the user with the system 100. The user on successful registration becomes a member of the social platform provided by the system 100. The registration module 240 can store the member profile in the database 110. Furthermore, the registration module 240 can allow the member to edit his profile including updating the profile picture. Moreover, the registration module can allow the members to update their login details including the password.

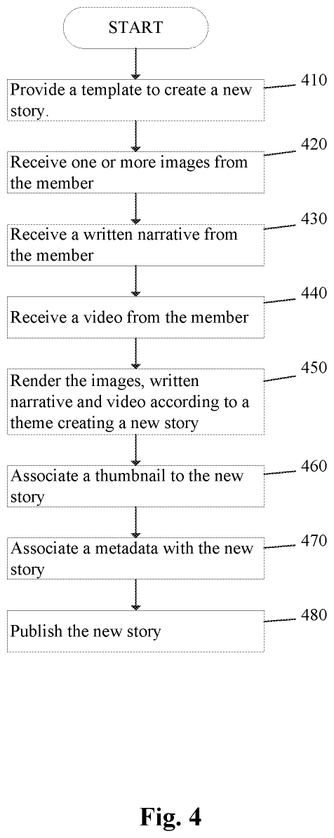

An embodiment of a new story module 250 is shown in FIG. 4 and described below. The new story module 250 allows for creating and posting new stories. The new story module 250 through the interface allows its members to publish a story, wherein the social platform provides a template for creating a new story. At step 410, the new story module 250 can provide a template to a member for submitting a new story. The member can request the template from the new story module 250, for example, a link can be shared with the member through the interface, wherein the member through the link can request the new story module 250 for a template. In one case, the template can be based on a category of the story. In another case, the template can be a common template. The template comprises of multiple pages with each page containing a text placeholder, a picture placeholder, and a video placeholder. To create a new story, first, the member can choose the number of pages for the new story. The new story module 250 can then receive one or more images from the member, at step 420. The image placeholder of the template, through the interface, may allow the member to upload one or more images. In one case, the member can upload at least one image for every page. The member can be provided an option to upload a picture from the user device 120. Alternatively, the member can be provided an option to upload an image from cloud storage. Furthermore, a user can choose from pictures already uploaded to the system 100. In a preferred embodiment, the member can draw an artistic image through the interface, wherein the member can be provided with a digital canvas. The canvas comprises a pen, color templates, eraser, and like which allows the member to create an artistic image from scratch. Furthermore, the canvas may also allow the member to edit any uploaded image.

At step 430 of FIG. 4, the member can provide a written narrative of the new story, through the text placeholder of the template. The user can write the text, upload a text file or paste the text in a text container. The written narrative can be saved and thereafter, the member can optionally upload a video, at step 440. The steps 420 to 440 of FIG. 4 can be repeated for each page of the new-story. The template can be associated with a theme, the theme includes the styles for the new story. The theme can include the font type, size, and color; background and foreground color or texture; arrangement of elements on a page; and like. The new story module 250 can provide one or more themes for the member, wherein the member can choose a theme from the available themes. Alternatively, the member can make a personalized theme. Still, the member can also edit an already available theme. At step 450, the new story module 250 can render the received images, written narrative and video according to a selected theme. At step 460, the new story module 250 can attach a thumbnail to the new-story. The thumbnail can be provided by the member, or the member can mark any one of the uploaded images at step 420 as a thumbnail. In case, the member does not provide a thumbnail, the new story module 250 can generate a thumbnail from the content uploaded by the member at step 420, 430 and 440. At step 470, the new story module 250 can generate metadata for the new story and associate the metadata to the new-story. The metadata can contain details of the new story, such as author, date and time of publishing the new-story, search keywords, and other details that can help to link, search and rate the story. The new story can then be published by the new story module, at step 480.

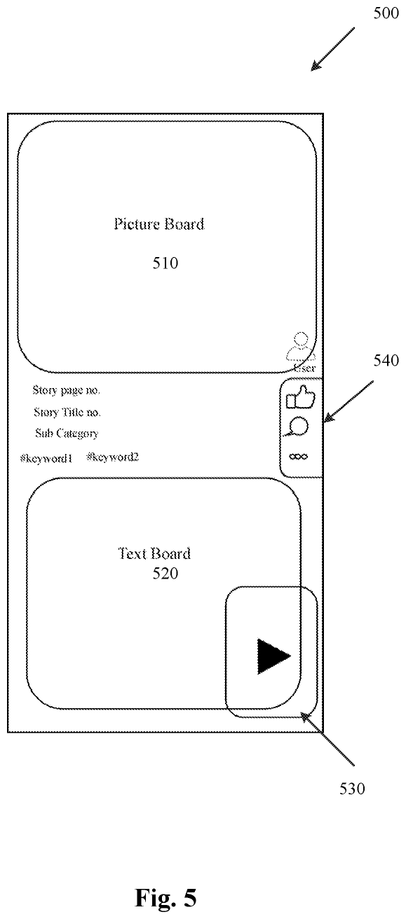

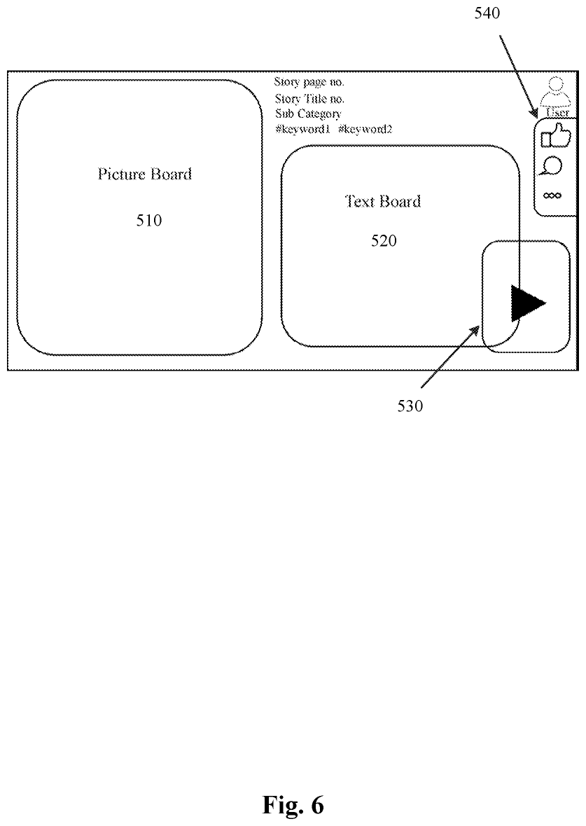

FIGS. 5 and 6 show an embodiment of the published story, as displayed by the interface. The window can be divided into the picture board and a text board. Between the two boards can be story page no., the title of the story, a sub-category of the story and search keywords. FIG. 5 shows one page 500 of the story, having an image displayed on the picture board 510, the written narrative provided in the text board 520. A floating window 530 can also be provided which presents the video. The picture board can be configured as a slider to provide multiple images as a slideshow. The position of the floating window can be adjusted by dragging the floating window to the desired corners on the visible screen area. Moreover, the video can be started and stopped at any time. Further, can be seen in FIGS. 5 and 6 is a widget 540, positioned on side of the page. The widget can be configured as a drawer, which can be pulled through the side of the screen. Above the widget can be provided details of the author of the post and the details can include the image or avatar of the author.

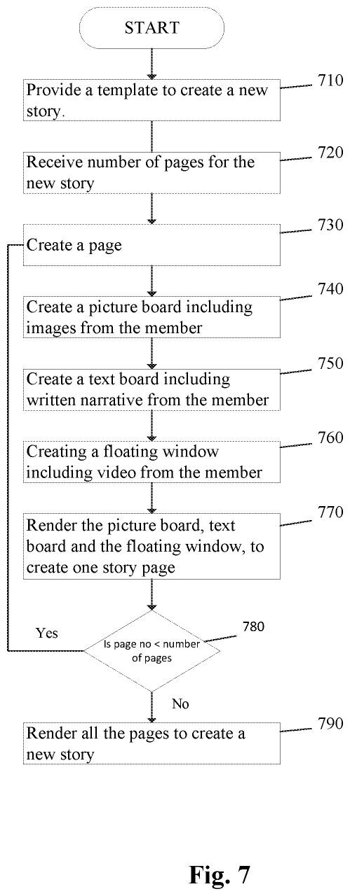

FIG. 7 shows an embodiment of creating a new story by the new story module 250. As discussed before, a template can be provided to the member at step 710. The member can then provide the number of pages the new story will have, at step 720. On providing the number of pages by the member, the first page can be created by the new story module 250, at step 730. The story page can be rendered to include the pictured uploaded by the member, making the picture board. Similarly, a text board can be rendered by the new story module 250 using the written narrative uploaded by the member, at step 750. A floating window can be created, at step 760, using the video uploaded by the member. Once, the picture board, text board, and the floating window have been created, the new story module 250 can render these to create a new story page, at step 770. At step 780, the new story module 250 can check if the created number of pages is less than the total number of pages selected by the member at step 720. If the created page no. is less than the number of pages, the steps 730 to 770 can be repeated to create another story page. Once, all the story pages have been created, the new story module 250 can then combine all the story pages to create the new story, at step 790.

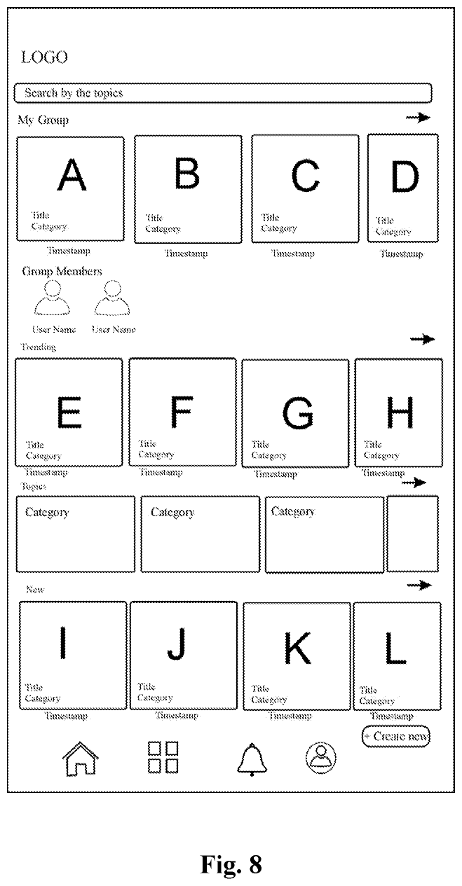

The interface module 260 of FIG. 2 can provide an interface through which the user can interact with the system 100. The interface present contents including the stories to the members and received input from the members. The interface can be adapted according to the display of the user device. For example, the smartphone is available for different display sizes and display ratio. Moreover, PDA can have a different display ratio. The interface can be adapted according to the different user devices. A single embodiment of content presented through the interface can be referred to as a page. FIG. 8 shows an exemplary embodiment of a landing page, also referred herein as the home page.

A page rendered by interface module 260, as shown in FIG. 8 is a home page, also referred herein as a landing page. The home page is a page that members see when they log into the social platform. The interface module 260 can provide multiple carousels arranged one above another in a parallel configuration, wherein each carousel can comprise multiple frames arranged side-by-side in the carousel. Each carousel is a collection of objects, each object represented in a frame. The object can be categorized based on an inherent property of the object. The home page is shown in FIG. 8 rendered in a landscape configuration, wherein the carousels can be arranged horizontally and parallel to each other. A carousel comprises a plurality of frames arranged side by side in the carousel. Each of the frames can be linked to a story, wherein the frame comprises a thumbnail, a title, and a label of the story. The frame can also represent a link to a collection of stories or objects such as members. In one case, the label can include the category of the story or author of the story. A limited number of frames in a carousel may be visible at a time, wherein a slider can be provided to each of the carousels for sliding through the frames. Also, can be displayed on the home page are search box, logo, group members, a menu bar and a create-story button. The menu bar provided at the bottom allows switching between different pages, the first icon linked to the home page, the second box-shaped icon linked to a browsing page, the third bell-shaped icon linked to a notification page, and the last icon linked to the member profile page. The create new button acts as a node for creating a new story. To create a new story, a member can click a node provided by the interface. In response to clicking the node, the member can be provided with a template for creating a new story. The member can upload one or more images, draw an image, or both upload the images and draw an image, provide a written narrative, and optionally upload a video.

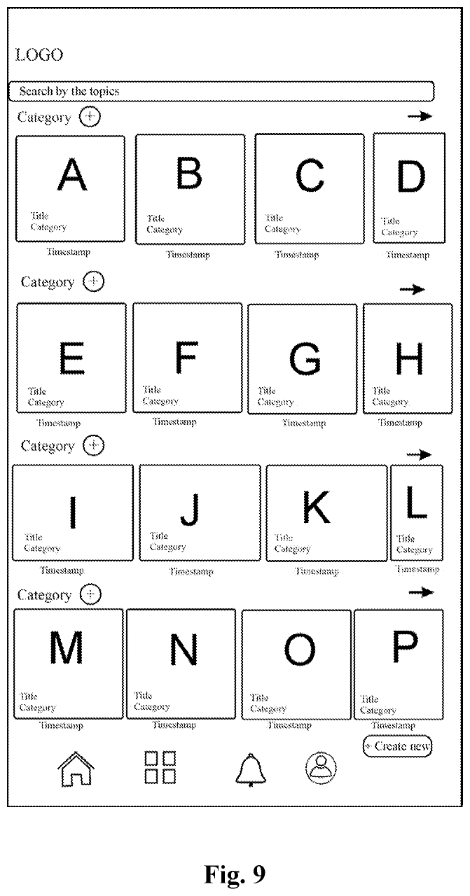

FIG. 9 discloses an embodiment of the browsing page, which is linked through the menu bar on the home page. The browsing page has stories arranged in rows with their titles at the bottom classified based on specific topics. Clicking on each story thumbnail opens story description. Next to the category is provided a node represented by the “+” symbol. Each of the nodes can trigger the new story module 250. The difference between this node next to a specific category and the node in the menu bar can be that the node that is next to a specific category can create category-specific stories.

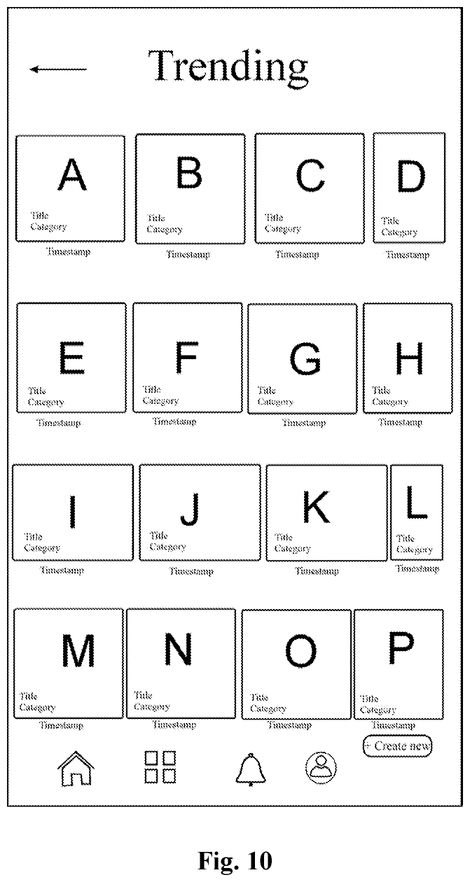

FIG. 10 discloses an embodiment of the “Trending” page, which is linked through a carousel on the home page, as rendered by the interface module 260. The “Trending” page has the most liked and interesting stories created by members arranged in the form of thumbnails. A label on each story thumbnail indicates a specific story topic followed by the title of the story. Clicking on each story thumbnail opens story description. At the bottom right there is a node for creating a new story.

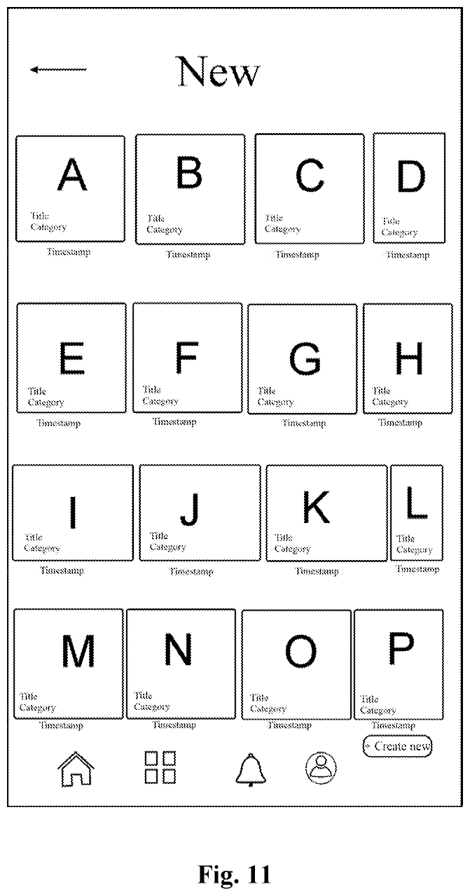

FIG. 11 discloses an embodiment of the “new” page, which is linked through a carousel on the home page, as rendered by the interface module 260. The “New” stories page has the most recent stories created by users that are represented by thumbnails. A label on each story thumbnail indicates a specific story topic followed by the title of the story. Clicking on each story thumbnail opens story description. At the bottom right there is a button for creating a new story.

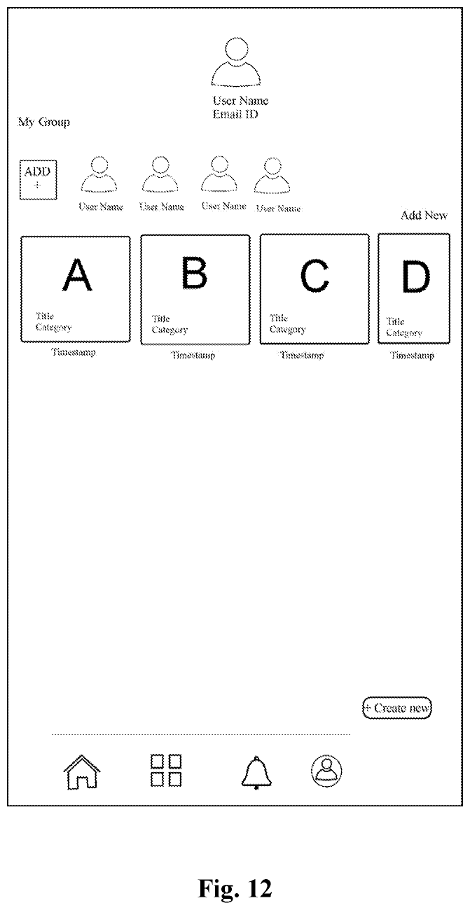

An embodiment of “my group” page can be seen in FIG. 12. The “my group” page can be linked through a carousel on the home page. On top of the page is an avatar of the member with a member name and email ID. Then below is the list of members of the workgroup arranged in a row followed by stories created by the members in a row. A label on each story thumbnail indicates a specific story topic followed by the title of the story. Clicking on each story thumbnail opens story description. At the bottom right there is a button for creating new story.

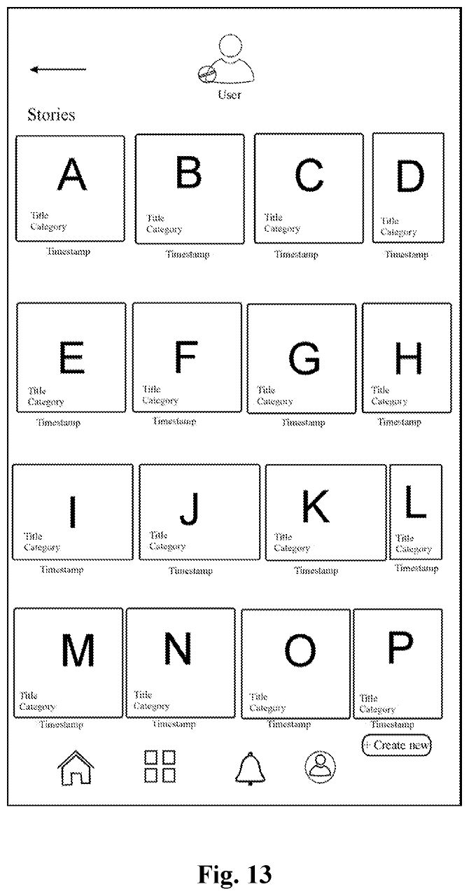

FIG. 13 discloses an embodiment of the “member stories” page, which is linked through a carousel on the home page, as rendered by the interface module 260. Clicking the member avatar/image anywhere is the interface that leads to a “member profile” page with the member's picture and stories arranged in the form of thumbnails created by the member. Clicking on each story thumbnail opens story description. A label on each story thumbnail indicates specific story topic followed by the title of the story.

The analysis module 270 in FIG. 2 allows recoding analytics details of the social platform, such as view of the story. Widget 540 shown in FIG. 5 can be linked to a rating code and a comment form. Moreover, the widget provides a link for sharing the stories. Any interaction with these links can be analyzed by the analysis module 270. Such data from the analysis module 270 can be used to ranks stories, for example, stories in the trending page can be based on ranking. Thus, a story getting likes or more comments can be ranked higher by the analysis module 270.

In one case, the present invention can provide for mentoring the members for creating the stories. Both a member based mentoring and professional mentoring can be provided. The member in a group, through the interface of the present invention can show their interest in mentoring other members in creating a new story. Such member can also be allowed to charge for their services. In one case, the members willing to mentor can include in their profile a tag indicating that they are providing services to other members. The members can also include fees for their services. For example, the member can include their experience, ratings, fee per hour and like in their profiles. Other members desirous to avail their services can look into available mentors and review their profiles. Furthermore, the interface can provide for calculating and making payments. Moreover, the platform can provide two types of memberships, paid and free. Wherein all features of the platform may not be available for free membership. Also, the interface of the present invention allows presenting commercial merchandise to the members of the platform. The present invention can allow its members to do affiliate marketing or associate commercial merchandise with their published stories. The members can present commercial merchandise either in their groups or to members of the platform in general.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for posting and sharing combined drawing-photo-text-video modular multimedia stories on a social platform, the method comprising:
providing, by a computing device, an interface for a user device to interact with the computing device;
receiving, by the computing device, one or more images from the user device for creating a new story;
receiving, by the computing device, a hand drawn art from the user device for creating the new story;
receiving, by the computing device, a written narrative from the user device for creating the new story;
receiving, by the computing device, a video from the user device for creating the new story;
processing, by the computing device, the one or more images, the hand drawn art, the written narrative, and the video based on a predetermined theme for publication of the new story; and
associating, by the computing device, a metadata to the new story, the metadata comprising details of the member authoring the story, date and time of posting the story.

2. The method of claim 1, wherein the method further comprises:
providing, by the computing device, a canvas to draw the hand drawn art.

3. The method of claim 1, wherein at least one or more of the images is configured as a thumbnail, the method further comprise a step of:
associating the thumbnail to the new story.

4. The method of claim 3, wherein the interface is configured to present a plurality of carousels arranged horizontally and parallel to each other, each of the plurality of carousels comprising a plurality of frames arranged side by side in the carousel, each of the plurality of frames comprises the thumbnail.

5. The method of claim 4, wherein the each of the plurality of frames further comprises a label.

6. The method of claim 5, wherein the label indicates a category of the new story.

7. The method of claim 1, further comprising:
posting the new story in a group, the group comprises a collection of members.

8. The method of claim 1, wherein the new story comprises a plurality of pages, each of the plurality of the pages comprising the written narrative and the one or more images.

9. The method of claim 8, wherein the method further comprises:
combining, by the computing devices, the plurality of the pages to create the new story.

10. The method of claim 8, wherein each of the plurality of pages comprises a picture board, a text board, and a floating window, the floating window configured to present the video.

11. The method of claim 10, wherein the picture board configured as a slide show for including the one or more images.

12. The method of claim 1, wherein the method further comprises:
publishing the new story; and
providing, by the computing device, a widget, the widget linked to the published story, the widget comprising a rating indicia and a comment indicia, the rating indicia linked to a rating code, and the comment indicia linked to a comment form.

13. The method of claim 1, wherein the user device is selected from a group consisting of a smartphone, laptop, desktop, tablet computer, and a personal digital assistant.

14. The method of claim 1, wherein the predetermined theme is created by a member.

15. The method of claim 1, wherein the interface provides for group member's interaction for writing multimedia stories, and the method further comprises mentoring for writing the new story and determining a fee for the mentoring.

16. The method of claim 1, wherein the interface allows group members to associate commercial merchandises to their published stories.

17. A system for posting and sharing stories on a social platform, the system comprising a server including a processor and a memory in communication with the processor, wherein the memory stores a set of instructions executable by the processor, the set of instructions when executed by the processor, cause the processor to:
provide an interface for a user device to interact with the computing device;
receive one or more images from the user device for creating a new story;
receive a hand drawn art from the user device for creating the new story;
receive a written narrative from the user device for creating the new story;
receive a video from the user device for creating the new story;
process the one or more images, the hand drawn art, the written narrative, and the video based on a predetermined theme for publication of the new story; and
associate a metadata to the new story, the metadata comprising details of the member authoring the story, date and time of posting the story.

18. The system of claim 17, wherein the system further:
provide a canvas to draw the hand drawn art.
